(19) United States
(12) Patent Application Publication
(10) Pub. No.: US 2013/0006783 A1
(43) Pub. Date: Jan. 3, 2013

(54) PORTABLE CHANGE DEVICE

(76) Inventor: Christos E. Vrahnos, Yorba Linda, CA (US)

(21) Appl. No.: 13/543,138

(22) Filed: Jul. 6, 2012

Related U.S. Application Data
(63) Continuation-in-part of application No. 12/568,104, filed on Sep. 28, 2009, now abandoned.

(51) Int. Cl. G06Q 20/20; G06Q 20/34

(52) U.S. Cl. 705/17

(57) ABSTRACT

A method and system for conducting a monetary transaction regardless of currency at the point of sale is provided. The method includes receiving a portable device that corresponds with a financial account, where the financial account includes financial account monetary value. The information regarding the financial account is stored on a network device, such as a cloud network. A predetermined amount of monetary units are exchanged for purchase at a point of sale, where the purchase includes a purchase price that is measured in monetary units. The predetermined amount of monetary units is subtracted from the purchase price to determine a change amount where the change amount is measured in at least one of a banknote value and a coin value. Data associated with the coin value of the change amount is saved to the financial account and the financial account is credited with the coin value of the change amount.

This application is a Continuation-In-Part application of U.S. application Ser. No. 12/568,104 filed Sep. 28, 2009 titled “Portable Change Device”, which is hereby incorporated by reference in its entirety.

### TECHNICAL FIELD

The present disclosure relates to a monetary transaction including a portable device that is credited with a change amount. In another aspect, the disclosure relates to a rewards and loyalty card to be used by a single commercial establishment or within a group of commercial establishments. The card is credited with the coin value of the change received from a transaction. It also accesses a remote data base, such as a cloud database, where information concerning the buyer is stored. This may include demographical information, income, purchase choices, etc. The card permits the seller to access that remote database. The buyer accrues reward points based upon the purchases made at the participating commercial establishments. Each establishment can access the information to provide coupons, rewards or any other incentive to the customer to purchase additional goods or services. The card further provides that the accumulated value of any coin change can be redeemed at the participating commercial establishments upon the purchase of additional goods and/or services, or the accumulated value of any coin change may be redeemed in the form of cash or check.

### BACKGROUND

A cashless transaction may be defined as a monetary transaction without using paper money or coins. Cashless transactions may include several advantages. For example, the need to carry large amounts of paper money, which can be misplaced or lost easily, is reduced. There are several approaches that may be used to conduct cashless transactions.

In one approach, debit and credit cards may be used instead of paper money. Credit cards are typically linked to a credit account, while debit cards may be linked to a bank account. A financial institution that manages the credit or bank account may charge a service fee each time the debit or credit card is used. Because there may be a service fee involved, credit and debit cards are usually used to make larger purchases.

In another example, prepaid cards may also be used instead of paper money. The prepaid card may be purchased with a predetermined monetary value that is associated with the card. In some cases, it is also possible to add money value to the prepaid card after the card has been purchased. However, the prepaid card may only allow a predetermined amount of money to be deposited on the card, such as, for example, in increments of twenty-five dollars. Moreover, at least some prepaid cards may not allow for money to be added once the card has been purchased.

Moreover, cashless transactions using credit cards and prepaid cards may not always eliminate the need to carry smaller increments of money. In particular, paper money and coin change may still need to be used in order to conduct transactions that involve smaller monetary values, such as, for example, purchases involving less than about five or ten dollars. However, using coin change may be burdensome, because coin change can be easily lost, and may be too bulky or heavy to carry in a wallet or purse. Therefore, it may be advantageous to reduce the amount of coin change that is exchanged in monetary transactions.

Goods and services providers may also desire additional information about their prospective customers to target their particular goods and services to the needs or desires of those customers. Oftentimes, the needs of the customers may be seen by resort to past behaviors and purchases. Existing reward and loyalty programs have been entirely satisfactory in achieving this goal because the customer often feels inundated with appeals to purchase from unfamiliar establishments or worse, that the commercial establishment has violated the consumer's privacy by keeping track of purchases and buying habits without the consumer's knowledge or consent. The disclosure addresses those issue by providing a portable device that keeps track of coin denominated change and permits to the consumer to control who has access of their purchasing habits,

Therefore, there exists a need to provide a cash card that may be credited with a change amount, where the change amount is measured in coins. The cash card may also be used to enroll in a selected loyalty and rewards program with selected commercial establishments, or a group of such establishments, thereby permitting the consumer to control access to their consuming habits and providing a convenient way to accept, store and spend coin change received in commercial transactions.

### BRIEF DESCRIPTION OF THE DRAWINGS

FIG. 1 is a diagram of an exemplary information distribution system including a point of sale, a communication device, a portable device, a financial account, and a network device;

FIG. 2A is an exemplary illustration of a front face of the portable device;

FIG. 2B is an exemplary illustration of a back face of the portable device in FIG. 2A; and

FIG. 3 is a process flow diagram of a conducting a monetary transaction using the portable device.

FIG. 4 is a process flow diagram of a consumer receiving the portable device wherein the consumer is enrolled in a loyalty and rewards program.

FIG. 5 is a process flow diagram of one embodiment of the disclosure as a rewards and loyalty portable device

### DETAILED DESCRIPTION

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive or otherwise limit or restrict the claims to the precise forms and configurations shown in the drawings and disclosed in the following detailed description.

Moreover, a number of constants may be introduced in the discussion that follows. In some cases illustrative values of the constants are provided. In other cases, no specific values are given. The values of the constants will depend on characteristics of the associated hardware and the interrelationship of such characteristics with one another as well as environmental conditions and the operational conditions associated with the disclosed system.

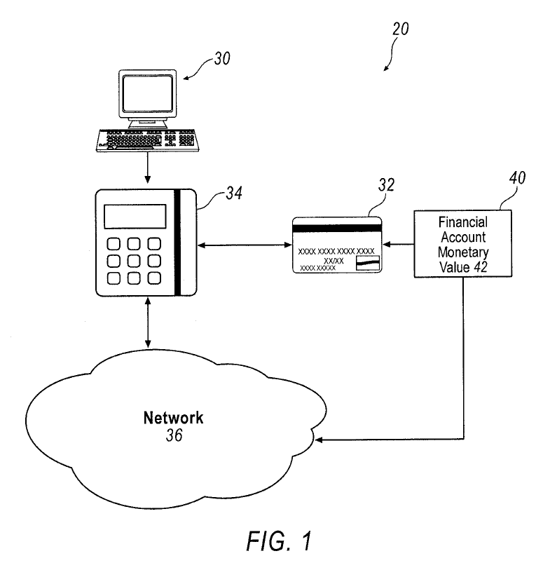

FIG. 1 illustrates an exemplary information distribution system 20, illustrated as a network for processing and storing monetary information. Typically, information distribution system 20 includes a portable device 32, illustrated as a card that may be similar in appearance to a traditional credit or debit card. The information distribution system 20 may also include a point of sale 30 and a communication device 34. It should be noted that while FIG. 1 illustrates the portable device 32 as a magnetic stripe card, any portable device capable of communicating financial information with the communication device 34 may be used.

In at least some situations, when a purchase is made at a point of sale, such as at the point of sale 30, a user may exchange a predetermined amount of money for the purchase. The purchase includes a purchase price. If the predetermined amount of money exceeds the purchase price, then a change amount may be given back to a user. The change amount may include a paper money value as well as a coin value. The portable device 32 may be credited with the coin value of the change amount using the information distribution system 20. Allowing the coin value of the change amount to be credited to the portable device 32 may reduce the amount of bulky, heavy coins that a user may have to carry. Moreover, the portable device 32 may also be used to make purchases as well, which is discussed in greater detail below.

The information distribution system 20 may include the point of sale 30, the portable device 32, the communication device 34, and a cloud network device 36. The point of sale 30 is illustrated as a computer register, however it should be noted that the point of sale 30 may be any device where a monetary transaction occurs. For example, a virtual point of sale may be used instead of the computer register 40, where the monetary transaction occurs over a telephone line, or a computer network. The point of sale 30 selectively communicates with the communication device 34. The communication device 34 selectively communicates with both of the portable device 32 as well as the cloud network device 36.

The portable device 32 is illustrated as a type of portable card, which may be similar in appearance to a credit or debit card. It should be noted that while FIG. 1 illustrates the portable device 32 as a portable card, any mobile device that stores monetary information or that may authenticate a user's identity may be used. For example, the portable device 32 may be a miniature card or a barcode device carried on a keychain. In another exemplary illustration, the portable device 32 may be an authentication token, such as an authentication token in communication with a radio frequency identification network. The communication device 34 may communicate information to and from the portable device 32. More specifically, the communication device 34 may be for reading and writing information from the cloud network device 36 to the portable device 32, as well as communicating information about the portable device 32 to the cloud network device 36.

FIG. 1 illustrates the communication device 34 as a type of magnetic swipe card reader. Although the communication device 34 is illustrated as a magnetic swipe card reader, it should be noted that the communication device 34 may be any device that obtains information during a monetary transaction. For example, the communication device 34 may be part of a radio frequency identification network, and may communicate with the portable device 32 wirelessly. In another example, the communication device 34 may be a barcode reader, where the communication device 34 scans a barcode located on the portable device 32. Moreover, the communication device 34 may read and write information from devices other than the portable device 32, such as, for example, credit, debit or gift cards. In another example, the communication device 34 may be a device that only reads and writes information from the portable device 32.

The portable device 32 corresponds with a financial account 40, where the financial account 40 includes a financial account monetary value 42. The financial account 40 may be located at a financial institution such as, for example, a bank or a credit union. Information regarding the financial account 40 may be stored directly on the portable device 32. Alternatively, information regarding the financial account 40 may be stored on the cloud network device 36.

The portable device 32 selectively communicates with the communication device 34 to transmit monetary information, such as information regarding the financial account monetary value 42, between the portable device 32 and the communication device 34. It should be noted that the portable device 32 may be any device that stores monetary information and allows for monetary information to be transmitted to the communication device 34, such as, for example a radio frequency identification card, an integrated circuit card or a magnetic swipe card.

The communication device 34 selectively communicates with the cloud network device 36 to transmit information between the portable device 32 and the cloud network device 36. More specifically, the communication device 34 communicates monetary information, such as the financial account monetary value 42 of the financial account 40, between the portable device 32 and the cloud network device 36. The financial account monetary value 42 may be stored on either of the portable device 32 and the cloud network device 36. In one example, the information distribution system 20 may be able to generate customized reports that identify several factors, such as, for example, the retail establishments the portable device 32 is used at or transaction amounts.

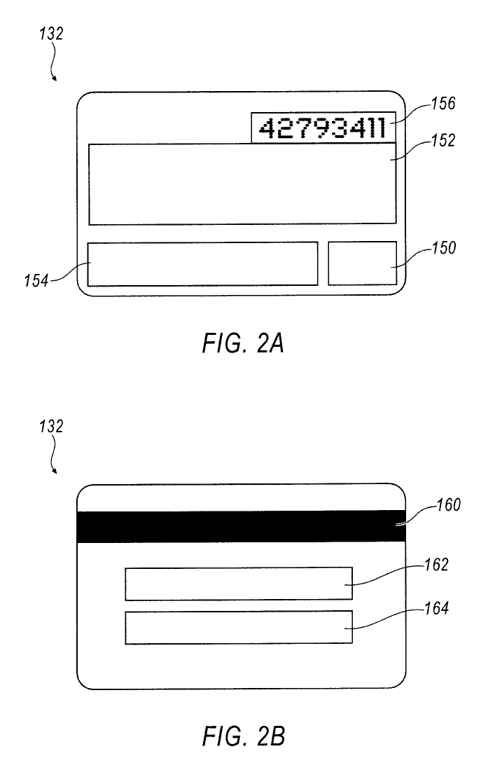

FIG. 2A is an exemplary illustration of the front face of a portable device 132, where the portable device 132 is a magnetic swipe card. The appearance of the portable device 132 may be similar to a conventional credit or debit card. A logo box 150 may be included, where the logo of a financial institution such as VISA® may be displayed. A graphic box 152 may also be included as well, where the graphic box contains information such as an account number, user name, and expiration date. The graphic box 152 may also include a graphic design, such as, but not limited to, a logo. In one exemplary illustration, the graphic box 152 may include a custom graphic design that is selected by a user of the portable device 132. In another illustration, the graphic box 152 may include a graphic design that is specially designed for the information distribution system 20. The portable device 132 may also include a slogan box 154 for containing text or images that are associated with an advertisement or a company slogan.

A display window 156 may also be included as well, where the display window 156 shows the current value of the financial account monetary value 42 (illustrated in FIG. 1). In one example, the display window 156 may be a digital display, such as, but not limited to, a vacuum fluorescent display or a liquid crystal display. The display window 156 may be updated with the current monetary value 42 of the financial account 40 after a financial transaction. In one example, the display window 152 may be in communication with a calculating device that is embedded inside of the portable device 132. It should be noted that while FIG. 2A illustrates the display window 156 on the front face of the portable device 132, the display window 156 may also be located on the back face of the portable device 132 as well.

FIG. 2B is exemplary illustration of the back face of a portable device 132. The back face includes a magnetic stripe 160, a signature block 162, and an information block 164. The magnetic stripe 160 may be a type of magnetic stripe that is typically used in credit and debit card transactions. Information such as, but not limited to, the monetary value of the financial account 40 may be included on the magnetic stripe 160. The magnetic stripe 160 may also include the identification a user, which may be used for verification purposes. The signature block 162 may also include the signature of a user. The information block 164 may be used to contain text, such as information regarding the portable device 132.

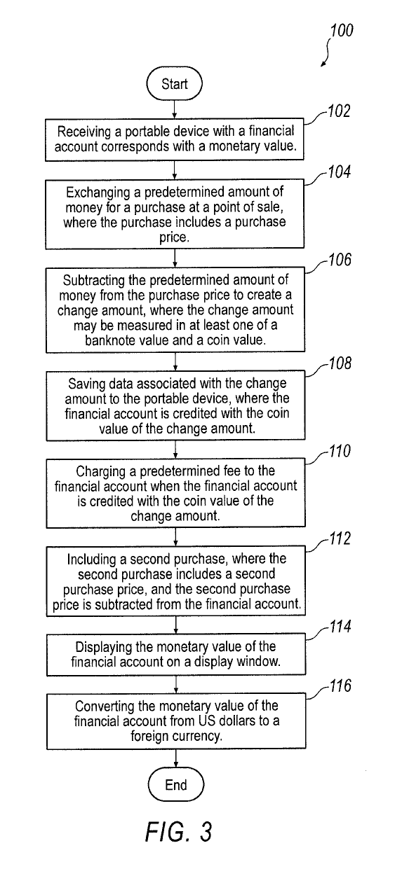

Use of the information distribution system 20 will now be explained. Turning to FIG. 3, a process 100 for using the information distribution system 20 is illustrated. Process 100 may begin at step 102, where the portable device 32 that corresponds with the financial account 40 may be received, where the financial account 40 includes the financial account monetary value 42 that is measured in monetary units. The financial account monetary value 42 may be stored on the cloud network device 36, alternatively, the financial account monetary value 42 may be stored directly on the portable device 32 as well.

In one example, the financial account monetary value 42 may be measured in monetary units corresponding with U.S. dollars, however, currency from any country in the world may be used as well. In another example, the financial account monetary value 42 may also be converted from U.S. dollars to foreign currency. The exchange rate may be based upon the current market rates at the time of the monetary transaction. The portable device 32 may be similar in appearance to a credit or debit card (see FIGS. 2A-2B) and may be accepted at any retail establishment where credit and debit cards are accepted. However, it is understood that the portable device 32 may be any mobile device that stores monetary information. Step 102 may then proceed to step 104.

In step 104, a predetermined amount of money may be exchanged for a purchase at the point of sale 30, where the purchase includes a purchase price. The purchase price corresponds with a value that may be measured in monetary units such as U.S. dollars. However, it is understood that currency from any country in the world may also be used with the information distribution system 20 as well. In one example, the predetermined amount of money is cash. Step 104 may then proceed to step 106.

In step 106, the predetermined amount of money is subtracted from the purchase price to determine a change amount. The change amount may be measured in at least one of a banknote value and a coin value. The banknote value may be an amount of monetary value that can be measured in paper money, and the coin value may be measured in coin money. For example, if a consumer pays with cash, and if the predetermined amount of money exceeds the purchase price of the purchase, a monetary value may be returned to the consumer. In particular, the monetary value that is returned to the consumer may include the banknote value, the coin value, or both banknote value and the coin value. In one example, the change amount may be measured in U.S. currency, and may include pennies, nickels, dimes, quarters, half-dollars and coin dollars. In another example, the change amount may be less than one U.S. dollar, and therefore the change amount can be measured only with the coin value. It is understood that the change amount may be measured using non-U.S. currency as well. Step 106 may then proceed to step 108.

In step 108, data associated with the change amount may be saved to the financial account 40, where the financial account 40 may be credited with the coin value of the change amount. Data may be saved to the portable device 32 in several ways. In one example, the portable device 32 includes magnetic stripe 160 (see FIG. 3). The portable device 32 is swiped though the communication device 34, where data associated with the coin value of the change amount may be saved to the portable device 32. In another example, the portable device 32 is a radio frequency identification card, where the portable device 32 communicates with a radio frequency identification network wirelessly to save data associated with the coin value of the change amount.

It should be noted that the coin value of the change amount from monetary transactions may be saved to the portable device 32 more than one time. That is, multiple monetary transactions may take place with the portable device 32, and with each monetary transaction, the coin value will accumulate. A user may decide to redeem the cash value of the financial account monetary value 42, especially if there is a large cash value accumulated. There are several different ways that the cash value of the financial account monetary value 42 may be redeemed. In one example, the financial account monetary value 42 may be redeemed at a bank, where the balance of the financial account monetary value 42 is deposited into a bank account. In another example the financial account monetary value 42 may be credited by a check. It should also be noted that the portable card 32 may be used to make monetary purchases as well, which is discussed in greater detail below. Step 108 may then proceed to step 110.

In step 110, a predetermined fee may be charged to the financial account 40 when the financial account 40 is credited with the coin value of the change amount. It should be noted that step 110 is an optional step, and that the predetermined fee may not be charged in at least some examples. The predetermined fee may be a service charge that is paid to the financial institution where the financial account 40 is located. The predetermined fee may be a percentage of the coin value of the change amount that is credited to the portable device 32. In one example, the predetermined fee is less than what credit and debit cards typically charge. However, the predetermined fee may be any legally authorized interest rate as well. Step 110 may then proceed to step 112.

In step 112, a second purchase may be made, where the second purchase includes a second purchase price measured in monetary units, and the second purchase price is subtracted from the financial account 40. That is, the portable device 32 may be used to pay for the second purchase, Monetary value may accumulate in the financial account 40, where monetary value is added to the financial account 40 each time the coin value of the change amount is saved to the portable device 32. As the value of the financial account 40 increases, a user may redeem the value of the financial account 40 by using the portable card 32 to pay for the second purchase. In one example, the second purchase may be a small value transaction. That is, the second purchase price may be a small monetary amount, such as, for example, on a scale of less than about five or ten dollars. However, it should be noted that the portable card 32 may also be used in larger monetary transactions as well, such as purchases that are more than ten dollars, as long as there are sufficient funds available in the financial account 40. It should be noted that step 112 is an optional step, and that step 112 may be omitted.

The predetermined fee may also be charged to the financial account 40 when the second purchase price is subtracted from the financial account 40. This means that the financial account monetary value 42 should be at least equal to the second purchase price of the second purchase, plus any associated fees in order to complete the second purchase.

In one example, the financial account monetary value 42 is verified by the cloud network device 36 to ensure that the financial account monetary value is at least equal to the second purchase price, plus any predetermined fees associated with the second purchase price. If the financial account monetary value 42 is not at least equal to the second purchase price plus the predetermined fee, then the monetary transaction may be declined. For example, in one illustration, if the second purchase is declined, the point of sale 30 may indicate that insufficient funds are available in the financial account 40.

It should be noted that because the predetermined fees may be a small percentage of the second purchase price, using the portable device 32 may not be cost prohibitive for making smaller purchases. That is, because the predetermined fee may be a small amount, such as a fraction of the second purchase price, a user may not be discouraged from utilizing the portable device 32, especially for smaller purchases that are about less than five or ten dollars. The portable device 32 may be different than from at least some other credit or debit cards that are available. This is because at least some credit or debit cards may change a standard fee for each monetary transaction, such as, for example, a two dollar service charge for each monetary purchase. Therefore, at least some users may be discouraged from using a credit or debit card to make smaller purchases, as a two dollar service charge is about forty percent (40%) of a five dollar purchase. In contrast, the portable device 32 may only charge a small fraction of the second purchase price. However, the portable device 32 may also charge any amount up to the legally authorized interest rate amount. Step 112 may then proceed to step 114.

In step 114, the financial account monetary value 42 may be displayed on the portable device 32. In the example as illustrated in FIGS. 2A and 2B, the portable device 132 may include the display window 156, where the display window 156 shows the current value of the financial account monetary value 42. it should be noted that step 114 is an optional step, and that the display window 156 may be omitted as well. The display window 156 may be updated with the current monetary value 42 of the financial account 40 after the data associated with the coin value of the change amount is saved to the portable device 132, which is discussed in step 108. Alternatively, the display window 156 may be updated with the current monetary value 42 of the financial account 40 after step 112 as well, where the second purchase price is subtracted from the financial account 40. Step 114 may then proceed to step 116.

In step 116, the financial account monetary value 42 may be converted from U.S. dollars into foreign currency. It should be noted that step 116 is an optional step, and may be used in situations where the financial transaction takes place in a country other than the United States, where U.S. currency may not be used. Process 100 may then terminate.

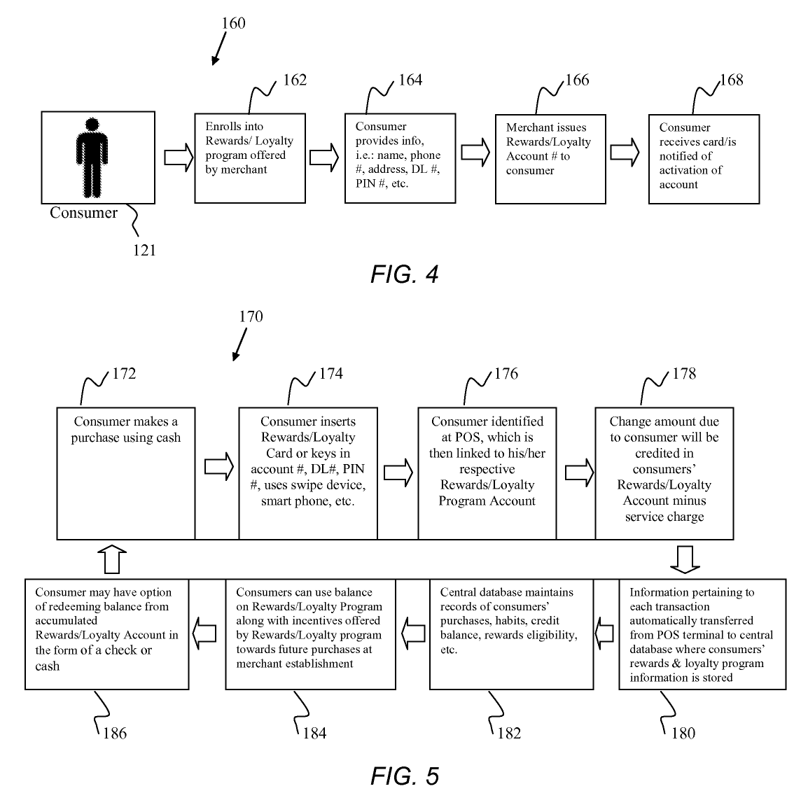

In another exemplary embodiment 160 as seen in FIG. 4, the portable device may be configured as a rewards and loyalty program. The consumer 121 may enroll in a rewards and loyalty type program 162 offered and administered by a commercial establishment, or group of such establishments. The consumer's information 164 may be stored by the commercial establishment in a central data base. This information may include, but is not limited to name, address, phone number(s), driver's license information, personal identification number (PIN), passwords, etc. Once this information is provided, at step 166 the commercial establishment (merchant) issues a rewards and loyalty portable device, such as a card with a magnetic strip or computer chip as previously described. The account is activated when the consumer receives the portable device as at step 168. The portable device (card) may be used by the consumer to capture coin change from any establishment, but al may be used at participating commercial establishments to participate in a rewards and loyalty program, wherein participating merchants provide incentives to the portable device holder based upon their purchases, as will be described in reference to FIG. 5.

In another exemplary embodiment 170, the portable device (card) operates as a rewards and loyalty program with a particular merchant or group of participating merchants. At step 172, when a consumer makes a purchase using cash, the consumer inserts the rewards and loyalty portable device into a POS, or inserts the PIN or driver's license number, uses a swipe device or smart phone or any other captured information to indentify the holder of the portable device as the legitimate owner. The coin value of any change due to the consumer may be credited to the rewards and loyalty program, less an optional service charge, as at 174. At step 176, information relating to each transaction is automatically transferred from the POS terminal to a central database where the consumer's Rewards and Loyalty Program information is stored.

At 178, the central database, maintains records of the consumer's purchases or commercial activities, habits, credit balance, rewards eligibility etc. As previously stated, the consumer does not feel violated that this information is collected and reviewed because he/she has elected to participate in the rewards and loyalty program. Consumers can then use the balance on the rewards and loyalty program along with incentives offered by merchants participating in the rewards and loyalty program toward future purchases at participating commercial establishments (merchants). The consumer may choose to participate in these incentives toward future purchases, or may elect as at 180, to receive the change value on the portable device in the form of cash or check, less a small service fee. The data base maintains records of the consumer's purchases as at step 182, and the consumer can use the balance on rewards and loyalty programs, along with rewards and loyalty program points towards future purchases, as at 184. The consumer has the option to redeem the balance from accumulated rewards and loyalty account points in the form of a check or as cash, as at step 186.

The present disclosure has been particularly shown and described with reference to the foregoing illustrations, which are merely illustrative of the best modes for carrying out the disclosure. It should be understood by those skilled in the art that various alternatives to the illustrations of the disclosure described herein may be employed in practicing the disclosure without departing from the spirit and scope of the disclosure as defined in the following claims. It is intended that the following claims define the scope of the disclosure and that the method and apparatus within the scope of these claims and their equivalents be covered thereby. This description of the disclosure should be understood to include all novel and non-obvious combinations of elements described herein, and claims may be presented in this or a later application to any novel and non-obvious combination of these elements. Moreover, the foregoing illustrations are illustrative, and no single feature or element is essential to all possible combinations that may be claimed in this or a later application.

What is claimed is:

1. A method of conducting a monetary transaction regardless of point of sale (POS) currency, comprising:
receiving a portable device that corresponds with a financial account, the financial account including a financial account monetary value, wherein information regarding the financial account is stored on a cloud network device;
exchanging a predetermined amount of monetary units for a purchase at a point of sale (POS), the purchase including a purchase price that is measured in monetary units;
subtracting the predetermined amount of monetary units from the purchase price to determine a change amount, the change amount measured in at least one of a banknote value and a coin value;
saving data associated with the coin value of the change amount to the financial account on the network device, where the financial account is credited with the coin value of the change amount; and
determining whether to convert the financial account monetary value from a first currency to a second currency depending upon the POS.

2. The method of claim 1, wherein the financial account monetary value is converted from U.S. currency to a foreign currency.

3. The method of claim 1, further including charging a predetermined fee to the financial account when the financial account is credited with the coin value of the change amount.

4. The method of claim 1, further comprising subtracting a second purchase price from the financial account, the second purchase price corresponding to a second purchase.

5. The method of claim 4, wherein a predetermined fee is charged to the financial account when the second purchase price is subtracted from the financial account.

6. The method of claim 1, further including displaying the financial account monetary value on the portable device.

7. The method of claim 6, wherein the portable device includes a digital screen for displaying the financial account monetary value.

8. The method of claim 1, wherein the portable device is one of a magnetic swipe card, a radio frequency identification card, an integrated circuit card, a bar code device, and an authentication token.

9. The method of claim 1, further including the steps of storing portable device user information data in a database, and providing access to such data to at least one third party preselected by said user of the portable device to provide incentives to said users of the portable device to purchase items at such third party.

10. The method of claim 9, wherein said information includes at least one of said user's driver's license number, personal identification number, name, telephone number, address, financial account value.

11. The method of claim 9, further including the steps of issuing an incentives and rewards program by said third party, wherein said third party is a group of participating merchants, and said information further including at least one of said user's purchases, commercial activities, habits, credit balance, or rewards eligibility.

12. A system for conducting a monetary transaction regardless of point of sale (POS) currency, comprising:
a financial account including a financial account monetary value;
a portable device corresponding with the financial account;
a POS for exchanging a predetermined amount of monetary value for a purchase, said purchase including a purchase price;
a database storing the value of the financial account;
a communication device for reading and writing information from the database to the portable device, the communication device in communication with the portable device the POS and the database;
a change amount measured in at least one of a banknote and a coin value, wherein the change amount is determined by subtracting the predetermined amount of money from the purchase price; and
an automatic conversion of currency feature dependent upon POS location, wherein the financial account is credited with the coin value of the change amount in a currency by the communication device.

13. The system of claim 12, wherein the portable device includes a digital screen for displaying the financial account monetary value.

14. The system of claim 12, wherein the portable device is one of a magnetic swipe card, a radio frequency identification card, an integrated circuit card, a barcode device, and an authentication token.

15. The system of claim 12, wherein the financial account monetary value is measured in US currency.

16. The system of claim 12, wherein said currency is converted from US currency to a foreign currency.

17. The system of claim 12, further including a data base to store portable device user information data, and provide access to such data to at least one third party pre-selected by said user of the portable device to provide incentives to said users of the portable device to purchase items at such third party.

18. The system of claim 17, wherein said information includes at least one of said user's driver's license number, personal identification number, name, telephone number, address, financial account value.

19. The system of claim 17, further including an incentives and rewards program by said third party, wherein said third party is a group of participating merchants, and said information further includes at least one of said user's purchases, commercial activities, habits, credit balance, or rewards eligibility.
